(19) United States
(12) Patent Application Publication
(10) Pub. No.: US 2022/0128182 A1
(43) Pub. Date: Apr. 28, 2022

(54) CONNECTOR ASSEMBLY FOR EARTH-BONDING OF A PIPING SYSTEM

(71) Applicants: Jonathon Lachlan Ivett, Nottingham (GB); Flexigas Ukc Ltd, Nottingham (GB)

(72) Inventor: Jonathon Lachlan Ivett, Nottingham (GB)

(21) Appl. No.: 17/432,238

(22) PCT Filed: Feb. 12, 2020
(86) PCT No.: PCT/GB2020/050319

§ 371 Date: Aug. 19, 2021

(30) Foreign Application Priority Data
Feb. 19, 2019 (GB) 1902280.5

(51) Int. Cl. F16L 25/01; F16L 25/00; H01R 24/56; H01R 4/36; H01R 4/64

(52) U.S. Cl. CPC F16L 25/01; F16L 25/0054; H01R 4/643; H01R 4/36; H01R 24/564

(57) ABSTRACT

A connector assembly for earth-bonding of a corrugated stainless steel tubing system is disclosed. The collector assembly incorporates a fitting to hold a tubing at least at one opening of the fitting, a collet at inner side of the at least one opening to enable sealing of the tubing, and a nut configured on outer side of the one or more opening of the fitting. The connector assembly can include one or more holes positioned at pre-defined positions on the fitting or nut to electrically couple one or more earth-bonding means at the one or more holes. The earthing means can include an earthing cable coupled to the fitting or the nut by an earth-bonding clamp or a tightening screw, which can be connected to an electrical earth or electric zero potential for providing earth-bonding.

### TECHNICAL FIELD

The present invention relates generally to the field of electrical earthing devices and more particularly to a connector assembly for earth-bonding of corrugated stainless steel tubing.

### BACKGROUND

Background description includes information that may be useful in understanding the present invention. It is not an admission that any of the information provided herein is prior art or relevant to the presently claimed invention, or that any publication specifically or implicitly referenced is prior art.

Earthing or Earth-bonding is the process of creating an alternative path for the flow of fault/excessive currents safely into the earth or ground (having electrically zero potential) in the presence of minimal resistance or impedance. The primary purpose of earthing is to reduce the risk of serious electric shock from current leaking into un-insulated metal parts of an appliance, power tool, or other electrically conductive systems. Earthing also provides protection from large electrical disturbances like lightning strikes and power surges. It also aids in the dissipation of hazardous static electrical charges developed over a system. Although most electrical systems have fuses or circuit breakers for protection against a fault current, the human body may be fatally electrocuted by a current of less than one ampere which is well below the point at which a fuse operated. Earthing helps minimize such hazards from occurring. Hence, good and efficient Earthing is an integral part of any system as it is directly related to the safety of human life as well as the equipment.

If someone inadvertently energizes a metallic gas pipe or other metallic pipes that has not been earth bonded, then it may electrocute someone who touches that metallic gas pipe and a grounded surface, as the person touching the energized gas pipe creates a path for the electric current to flow through them.

Earthing is required to prevent a possible electric hazard for persons that may be in contact with gas piping such as corrugated stainless steel tubing and other grounded metallic components. Gas piping can become energized by an electrical fault in the branch circuit of a gas appliance connected to the piping system. A nearby lightning strike can also result in an unbalanced voltage build-up and result in a high electrical potential difference. That potential difference can cause an electrical arc between the gas piping and another nearby metallic system such as copper water piping, electric wiring, or structural steel. The arc may be sufficient to cause damage to thin walled gas tubing systems like corrugated stainless steel tubing.

The use of corrugated stainless steel tubing has become widespread for use in gas piping system around the world. In many jurisdictions it is a strict requirement to electrically earth-bond all gas piping system, including installations made using corrugated stainless steel tubing. However, the installation of an earth-bonding clamp to corrugated stainless steel tubing can be problematic as it is not possible or permissible to attach earth-bonding clamps directly to corrugated stainless steel tubing. This limits the earth-bonding clamp to be either attached around a connector assembly or fitting (which is used for connecting lengths of corrugated stainless steel tubing), or around a rigid section of pipe such as copper or rigid steel, installed in the piping system usually near the gas meter.

Attaching an earth-bonding clamp around a connector assembly is disadvantageous, as the body of the fitting or the nut of the connector assembly on which the earth-bonding clamp is to be attached must have a larger diameter compared to that of normal rigid tubing. This means that an oversized earth-bonding clamp needs to be sourced, which may be expensive to purchase and difficult for the installer to find and assemble.

Attaching the earth-bonding clamp around a rigid length of the gas piping system is again disadvantageous as this means that corrugated stainless steel tubing cannot be used for the entire gas installation. For instance, a small section of the installation, usually near the gas meter, must be installed using copper or rigid steel on which the bonding clamp is attached before switching to corrugated stainless steel tubing thereafter.

There is, therefore, a need to provide an earth-bonding means that can be directly coupled to a connector assembly of corrugated stainless steel tubing, which is economical, compact and easy to configure.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### OBJECTS

It is an object of the present disclosure to provide a connector assembly for connecting a plurality of lengths of corrugated stainless steel tubing.

It is an embodiment of the present disclosure to provide earth-bonding to a corrugated stainless steel tubing installation.

It is an object of the present disclosure to provide a connector assembly for earth-bonding of a corrugated stainless steel tubing system.

It is an object of the present disclosure to provide a connector assembly for earth-bonding of a corrugated stainless steel tubing system, which is compact and easy to operate.

It is an object of the present disclosure to provide a connector assembly for earth-bonding of a corrugated stainless steel tubing system, which is economical and easy to assemble.

### SUMMARY

The present invention relates generally to the field of electrical earthing devices and more particularly to a connector assembly for earth-bonding of a corrugated stainless steel tubing system.

An aspect of the present disclosure pertains to a connector assembly for earth-bonding of corrugated stainless steel tubing, the connector assembly comprising: a fitting comprising at least one opening to hold one end of at least one length of corrugated stainless steel tubing; a sealing mechanism, whereby a fluid seal is achieved between the corrugated stainless steel tubing and the fitting; a nut configured on an outer side of the at least one opening of the fitting; wherein the connector assembly comprises one or more holes positioned at one or more pre-defined positions, said one or more holes configured to hold one or more earth-bonding means to facilitate earth-bonding of the corrugated stainless steel tubing.

The connector assembly as claimed provides a compact and convenient means to receive or attach an earth-bonding means thereto. Compact earth-bonding means may be used with such connector assembly, thus negating the need and expense to source earth-bonding means having a larger diameter to that of normal rigid tubing, which may be expensive and difficult to find. Furthermore, the connector assembly as claimed can be attached to the corrugated stainless steel tubing directly, meaning the corrugated tubing can be used for the entire gas installation, thus minimising installation time and cost.

In an aspect, the one or more predefined positions may be on the fitting and may be present at any one or a combination of the following positions: around the circumference of the fitting, radially outer side of the fitting, and parallel to radially outer side of the fitting.

In another aspect, the one or more earth-bonding means may include an earth-boding earthing cable configured to said one or more holes on the fitting by at least one of an earth-bonding clamp and a tightening screw, said earth-bonding earthing cable may be electrically coupled to an electrical earth.

The one or more holes may be positioned at the one or more pre-defined positions on the fitting, said one or more holes may be configured to hold the one or more earth-bonding means to facilitate earth-bonding of the corrugated stainless steel tubing.

In another aspect, the one or more first holes may be positioned at the one or more pre-defined positions on the nut, said one or more first holes may be configured to hold the one or more earth-bonding means to facilitate earth-bonding of the corrugated stainless steel tubing.

In yet another aspect, the one or more predefined positions on the nut may be present at any or a combination of the following positions: around the circumference of the nut, radially outer side of the nut, and parallel to radially outer side of the nut.

In an aspect, the one or more earth-bonding means may be an earth-bonding earthing cable configured to said one or more holes of the nut by at least one of an earth-bonding clamp and a tightening screw, said earth-bonding earthing cable may be electrically coupled to an electrical earth.

In another aspect, the sealing mechanism may include a sealing member configured between the outer side of the at least one opening of the fitting and the nut. This prevents fluid from escaping the corrugated stainless steel tubing and the system.

The sealing mechanism may include a split collet, an inner side of the collet comprising a radially inward protruding structure configured to engage with a corrugated structure of the corrugated stainless steel tubing.

In yet another aspect, rotation of the nut along the outer side of the at least one opening of the fitting may enable compression or contraction of at least one corrugation of the corrugated stainless steel tubing between the collet and the fitting, thereby sealing the corrugated stainless steel tubing to the connector assembly. Additionally or alternatively, the rotation of the nut may enable contraction of the sealing member as well as the collet against an outer surface of the one end of the at least one length of corrugated stainless steel tubing, thereby sealing the at least one opening.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1A and 1B illustrate exemplary side views of the proposed connector assembly for earth-bonding of a corrugated stainless steel tubing system, in accordance with a first embodiment and a second embodiment respectively of the present disclosure.

FIGS. 1C and 1D illustrate exemplary side view of an embodiment of the proposed connector assembly for earth-bonding of a corrugated stainless steel tubing system, in accordance with a third embodiment of the present disclosure.

FIG. 1E illustrates an exemplary top view of the nut of the present disclosure, in accordance with the third embodiment of the present disclosure.

FIG. 1F illustrates an exemplary perspective view of a further embodiment of the nut of the present disclosure, in an embodiment of the present disclosure.

FIGS. 2A, 2B and 2C illustrate exemplary side view and top view respectively of an embodiment of the proposed connector assembly coupled with an earth-bonding clamp, in accordance with a fourth embodiment of the present disclosure.

FIG. 2D illustrates an exemplary top view of an embodiment of the nut of the proposed connector assembly coupled with an earth-bonding clamp, in accordance with the fourth embodiment of the present disclosure

FIGS. 3A, 3B and 3C illustrates perspective views of further exemplary embodiments of nut of the proposed connector assembly, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Various terms as used herein are shown below. To the extent a term used in a claim is not defined below, it should be given the broadest definition persons in the pertinent art have given that term as reflected in printed publications and issued patents at the time of filing.

The present invention relates generally to the field of electrical earthing devices and more particularly to a connector assembly for earth-bonding of a corrugated stainless steel tubing system.

It is to be appreciated that while various embodiments of the present disclosure have been described with reference the coupling of the corrugated stainless steel tubing system to electrical earth for earth-bonding or earthing, however the concept of earth-bonding in the present disclosure can be implemented by electrically coupling the corrugated stainless steel tubing system with any zero (or ground) potential object or surface or directly to earth (or ground) and all such embodiments are well within the scope of the present disclosure without any limitations whatsoever

In an aspect, the present disclosure elaborates upon a connector assembly for earth-bonding of a corrugated stainless steel tubing system, the connector assembly may include: a fitting including at least one opening to hold one end of at least one pipe of the piping system; a collet configured at its inner side of the at least one opening to enable tightening of the at least one length of corrugated stainless steel tubing in the at least one opening; and a nut configured on the outer side of the at least one opening of the fitting; wherein the fitting may include one or more holes positioned at pre-defined positions on the fitting, said one or more holes configured to hold one or more earth-bonding means to facilitate earth-bonding of the piping system.

In an embodiment, the predefined positions on the fitting can be present at any one or a combination of positions around circumference of the fitting, radially outer sides of the fitting, and parallel to radially outer sides of the fitting.

In an embodiment, the earth-bonding means can be an earthing cable configured to one or more holes of the fitting by any or a combination of an earth-bonding clamp or a tightening screw, said earth-bonding earthing cable is electrically coupled to electrical earth.

In an embodiment, the inner side of the collet can include a radially inward protruding structure configured to engage with the corrugated structure of the at least one pipe.

In an embodiment, the nut can include one or more first holes positioned at pre-defined positions on the nut, said one or more first holes configured to hold the one or more earth-bonding means to facilitate earth-bonding of the corrugated stainless steel tubing system.

In an embodiment, the predefined positions on the nut can be present at any or a combination of positions around circumference of the nut, radially outer sides of the nut, and parallel to radially outer sides of the nut.

In an embodiment, the earth-bonding means can be an earthing cable configured to one or more first holes of the nut by any or a combination of an earth-bonding clamp or a tightening screw, said earth-bonding earthing cable is electrically coupled to electrical earth.

In an embodiment, a sealing member can be configured between the outer surface of the at least one opening and the nut.

In an embodiment, rotation of the nut along the outer side of the at least one opening of the fitting can enable contraction of the sealing member as well as the collet against an outer surface of the one end of the at least one length of corrugated stainless steel tubing, thereby sealing the at least one opening.

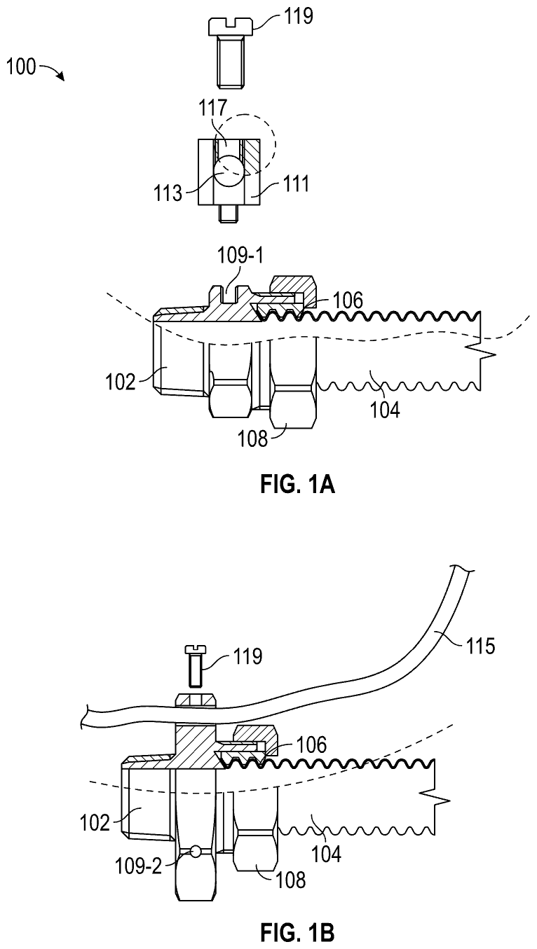

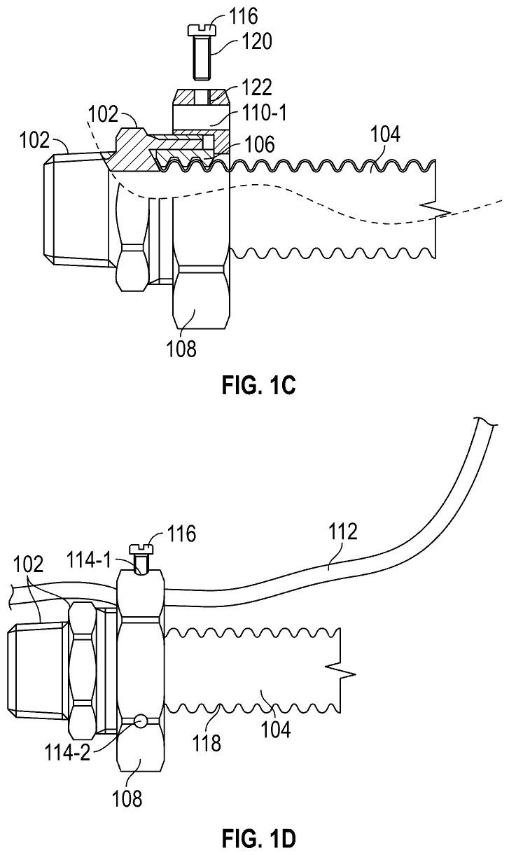

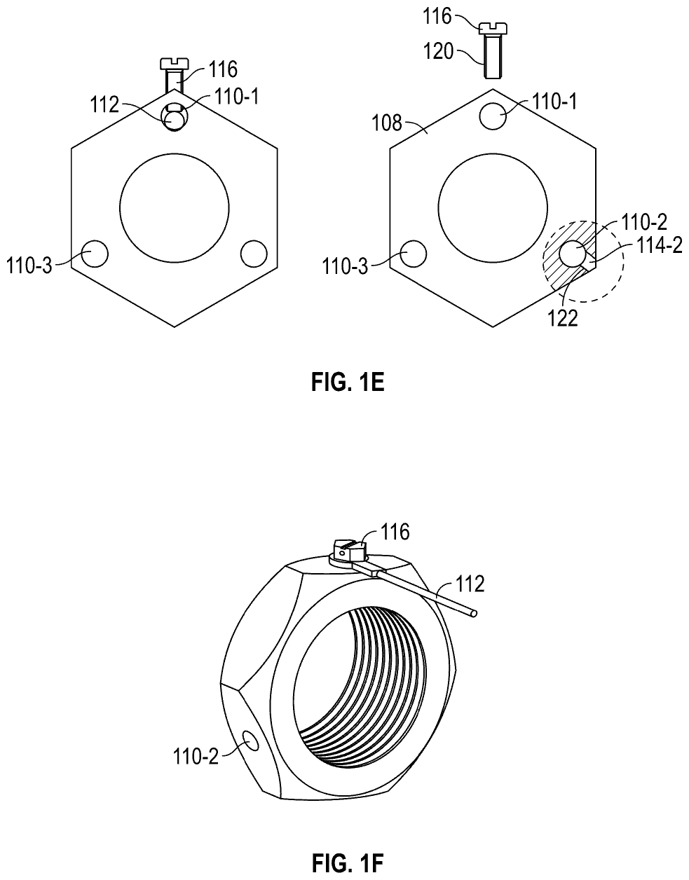

FIGS. 1A & 1B illustrate exemplary side views of the proposed connector assembly for earth-bonding of a piping system, in accordance with the first embodiment and the second embodiment respectively of the present disclosure.

According to an embodiment, the connector assembly 100 as illustrated for a piping system can include a fitting 102 preferably configured to connect multiple lengths of corrugated stainless steel tubing 104. The fitting 102 can include at least one opening to hold one end of the length of corrugated stainless steel tubing. The fitting 102 can have a hollow structure which can allow passage of fluids between lengths of corrugated stainless steel tubing. For instance, as illustrated in figures, the fitting 102 can hold a length of corrugated stainless steel tubing 104 at one of the at least one opening of the fitting 102.

A sealing mechanism is preferably provided in the connector assembly 100. In an embodiment, the connector assembly 100 can include a collet 106, which may form part of a sealing mechanism, configured at its inner side of the at least one opening of the fitting. The collet 106 can be configured to tighten one end of the corrugated stainless steel tubing 104. The collet 106 may be a type of chuck that can form a collar around the one end of the corrugated stainless steel tubing 104 and can exert a strong clamping force on the tube when it is tightened.

In an embodiment, the connector assembly 100 can include a nut 108 configured around the outer side of the at least one opening of the fitting 102, such that rotation of the nut 108 around the outer side of the at least one opening squeezes or contracts the collet 106 against the at least one corrugation of the corrugated stainless steel tubing 104, thereby compressing the at least one or more corrugations of the corrugated stainless steel tubing 104 against a sealing surface of the fitting.

In an embodiment, the connector assembly 100 can include a sealing member (also referred to as sealing surface, herein), which may form part of the sealing mechanism, configured between the outer surface of the at least one opening and the nut. The sealing member can enable sealing of the gap between the tube and the fitting, which can prevent leakage of fluids in the piping system.

In an embodiment, the rotation of the nut 108 around the outer side of the at least one opening squeezes or contracts the sealing surface as well as the collet 106 against the one end of the corrugated stainless steel tubing 104, thereby by sealing any gap between the fitting 102 and the tubing 104. Alternatively, the collet may have a uniform or substantially uniform outer surface diameter along its axial extent, such that a tight interference fit is formed with the corresponding inner side of the at least one opening of the fitting. Rotation of the nut causes the collet to urge and clamp the one end of the corrugated stainless steel tubing against the inner side of the at least one opening of the fitting, thereby sealing any gap between the fitting and the tubing.

In an embodiment, the fitting 102 can include one or more holes, namely 109-1 and 109-2 (collectively referred to as one or more holes 109, herein) positioned at one or more pre-defined positions on the fitting 102 and configured to hold one or more earth-bonding means to facilitate earth-bonding of the corrugated stainless steel tubing.

In an embodiment, the predefined positions of the one or more holes 109 on the fitting 102 can be present at any or a combination of the following positions: around the circumference of the fitting 102, radially outer side of the fitting 102, and parallel to radially outer side of the fitting 102.

As illustrated in FIG. 1A, the earth bonding means can include an earth-bonding clamp 111 fastened to the one or more holes 109-1 of the fitting positioned at circumferences of the fitting 102, said earth-bonding clamp 111 is electrically coupled to electrical earth by an earthing member such as an earthing cable 115.

In an embodiment, the earth-bonding clamp 111 can include a first hole 113 configured to allow passage of the earthing cable 115 through it. In an exemplary embodiment, a second hole 117 can be drilled perpendicular to the first hole 113 such that the second hole 117 facilitates fastening of the earthing cable by a tightening screw 119.

As illustrated in FIG. 1B, the one or more holes 109 can be positioned around the circumference of the fitting 102 and configured to allow fastening of the earthing cable 115 through it. In an exemplary embodiment, a hole can be drilled on the fitting 102, perpendicular to the one or more holes of the fitting 102, which can facilitate fastening of the earthing cable 115 at the fitting 102 by a tightening screw 119. Thus, the one or more holes 109 as illustrated in FIG. 1B may serve the same or similar function as the second hole 117 as illustrated in FIG. 1A, both configured to receive the tightening screw 119.

In an exemplary embodiment, a body of the fitting 102 can include radially extending structure which can facilitate positioning of the one or more holes 109 at the one or more pre-defined positions.

FIGS. 1C and 1D illustrate exemplary side view of an embodiment of the proposed connector assembly for earth-bonding of a piping system, in accordance with a third embodiment of the present disclosure

According to an embodiment, the nut 108 of the connector assembly 100 can include one or more first holes, namely 110-1 to 110-3 (collectively referred to as one or more first holes 110, herein), positioned circumferentially around the nut 108 at pre-defined positions.

In an embodiment, one or more earth bonding means can be electrically coupled to the nut 108 at its one end and to earth or ground or any zero electrical potential means at its other end, for earth-bonding the multiple pipes of the piping system.

In an embodiment, an earthing cable 112 can be coupled to the nut 108 at the one or more first holes 110. In an exemplary embodiment, the earthing cable 112 (also referred to as cable, herein) can pass through the one or more holes 110-1. Thus, the one or more first holes 110 as illustrated in FIG. 1C and FIG. 1D may serve the same or similar function as the first hole 113 as illustrated in FIG. 1A and FIG. 1B, all configured to allow passage of the earthing cable.

In an embodiment, the earthing cable 112 can be electrically coupled to the nut 108 at the one or more first holes 110. In an exemplary embodiment, the earthing cable 112 can be an electrically conducting cable connected to earth or ground having electrically zero potential. The earthing cable can be insulated around its outer surface for safety purposes, but the section of the cable touching the nut at the one or more holes does not have any insulation and the conducting part of the cable can be in contact with the nut or the fitting.

In an embodiment, one or more second holes 114-1 to 114-3 (collectively referred to as one or more second holes 114, herein) can be positioned at a radially outer side of the nut 108, perpendicular to the pre-defined positions of the one or more first holes 110 of the nut 108, such that bores of the one or more first holes 110 are connected to or in communication with the bores of the one or more second holes 114 at the pre-defined positions.

For instance, the bore of the one or more first hole 110-1 can be connected to the bore of the one or more second hole 114-1, and bores of the one or more first holes 110-2 and 110-3 are connected to the bores of the one or more second holes 114-2 and 114-3 respectively, in a similar manner.

In an embodiment, the earthing cable 112 passing through the one or more first holes 110 can be clamped into place by one or more holding screws 116. The one or more holding screws 116 can be inserted in the one or more second holes 114 of the nut 108, which can enable fastening of the earthing cable 112 to the nut 108 at the one or more first holes 110.

In an embodiment, the inner side of the collet can include a radially inward protruding structure or finger which protrudes into the one or more corrugations of the corrugated stainless steel tubing 104. The protruding structure of the collet can engage with the corrugated structure 118 present on the outer surface of one end of the corrugated stainless steel tubing 104.

FIG. 1E illustrates exemplary top view of the nut of the present disclosure, in the third embodiment of the present disclosure.

As illustrated in FIG. 1E, the nut 108 of the proposed connector assembly 100 is shown. In an embodiment, the nut 108 can be of hexagonal profile (having six faces on the radially outward surface) that can include one or more first holes 110 positioned around the circumference of the nut 108 at alternate corners of the hex profile of the nut.

It is to be appreciated that while various embodiments of the present disclosure have been elaborated with reference to a nut having hexagonal profile along a radially outer side, however the present disclosure can be implemented using nuts having any profile (any number of radially outward faces) and all such embodiments are well within the scope of the present disclosure without any limitations whatsoever.

In an embodiment, one or more second holes 114 can be positioned at the radially outer side of the nut 108, perpendicular to the one or more first holes 110 at alternate corners of the hexagonally profiled nut.

In an embodiment, the one or more second holes 114 can be positioned such that bores of the one or more first holes 110 and the one or more second holes 114 are connected to or in communication with each other.

In an embodiment, the one or more second holes 114 can accommodate a plurality of holding screws, such that the plurality of holding screws can fasten the earthing cable passing through the one or more first holes. As illustrated a holding screw 116 can enable fastening of the earthing cable 112.

In an exemplary embodiment, the holding screw 116 can have a male mating thread 120 around its surface that can engage with a female mating thread 122 present on an inner surface of the one or more second holes 114 of the nut 108.

In an exemplary embodiment, the holding screw 116 can have a female mating thread around its surface that can engage with a male mating thread on the inner surface of the one or more second holes.

In an embodiment, the nut 108 can include an interior female thread or interior male thread on the inner surface of the nut, which can engage with an exterior male thread or exterior female thread radially extending outward from the outer surface of the at least one opening of the fitting.

FIG. 1F illustrates an exemplary perspective view of a further embodiment of the nut of the present disclosure, in an embodiment of the present disclosure.

As illustrated, the nut of the proposed connector assembly can include one or more first holes 110, with the earthing cable 112 coupled to the one or more first hole 110-1 (not shown in figure), and fastened by the holding screw 116 at the one or more first hole 110-1.

In an embodiment, the radially inner surface of the nut 108 can include interior female thread or interior male thread, which can engage with an exterior male thread or exterior female thread (not shown in figure) present on the outer surface of the at least one opening of the fitting, such that the engagement of the exterior male/female thread of the one or more opening and the interior female/male thread of the nut 108 compresses the corrugated stainless steel tubing into a sealed position.

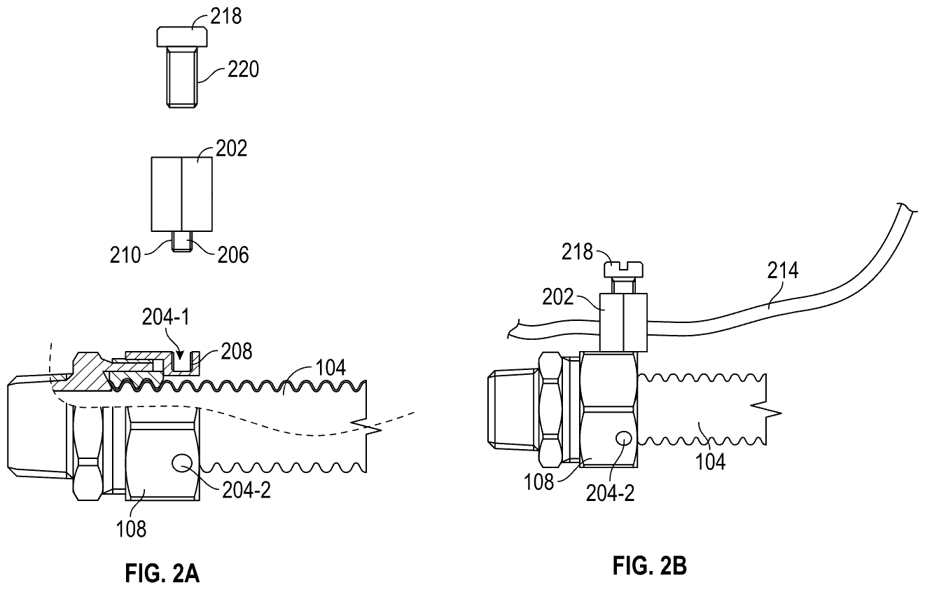

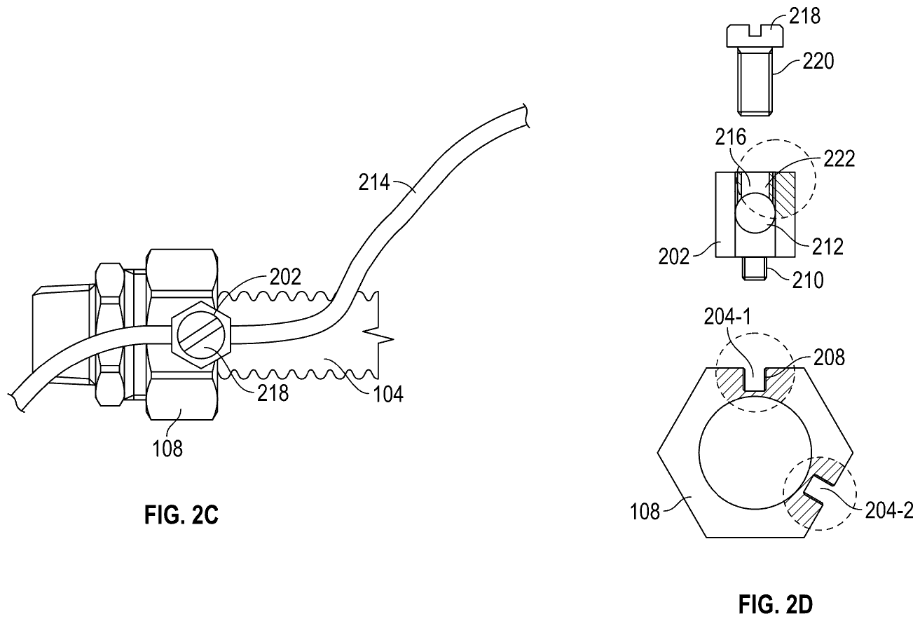

It will be appreciated that the nut 108 illustrated in FIG. 1E or FIG. 1F may be utilised on any one of the embodiments illustrated in FIG. 1A, FIG. 1B, FIG. 1C, FIG. 1D, FIG. 2A, FIG. 2B, FIG. 2C and FIG. 2D.

FIG. 2A to 2C illustrate exemplary side views and top view respectively of an embodiment of the proposed connector assembly coupled with an earth-bonding clamp, in accordance with a fourth embodiment of the present disclosure.

According to an embodiment, a connector assembly with an earth-bonding clamp coupled to it is shown. The connector assembly 100 (as elaborated in FIGS. 1C and 1D) can include an earth-bonding clamp 202 fastened to a plurality of first holes 204-1 and 204-2 (collectively referred to as plurality of first holes 204, herein) positioned at a radially outer side of the nut.

In an embodiment, the earth-bonding clamp 202 can be fastened to the one or more first holes 110 of the nut as elaborated in FIGS. 1C and 1D, which are positioned circumferentially around the nut 108 at predefined positions, or the earth-bonding clamp 202 may be fastened to the one or more second holes 114 of the nut 108 as elaborated in FIGS. 1C and 1D.

In an embodiment, the earth-bonding clamp 202 can include a male coupling member 206, which can engage with the plurality of first holes 204. In an exemplary embodiment, the inner surface of the plurality of first holes 204 can include a female thread 208, which can engage with an outer surface of the male coupling member 206 having a male thread 210. Alternatively, the plurality of first holes can include a male thread to engaged with a female coupling member having a female thread.

In an embodiment, the earth-bonding clamp 202 can include a first hole 212 drilled through two opposite surfaces of it, which can facilitate the electrical coupling of an earthing cable 214 to it. The earthing cable 214 can pass through the first hole 212 of the earth-bonding clamp 202 with at least an electrically conducting part of the earthing cable 214 touching the earth-bonding clamp 202. Thus, the first hole 212 as illustrated in FIGS. 2A to 2D may serve the same or similar function as the first hole 113 as illustrated in FIG. 1A and FIG. 1B and the one or more first holes 110 as illustrated in FIG. 1C and FIG. 1D, all configured to allow passage of the earthing cable.

In an embodiment, the earth-bonding clamp 202 can include a second hole 216 positioned on a side perpendicular to the two opposite surface of the earth-bonding clamp 202, such that bores of the first hole 212 and the second hole 216 are perpendicular and also connected to each other. The second hole 216 can enable insertion of a holding screw 218 that can facilitate tightening of the earthing cable 214 in the first hole 212. Thus, the second hole 216 as illustrated in FIGS. 2A to 2D may serve the same or similar function as the second hole 117 as illustrated in FIG. 1A and the one or more holes 109 as illustrated in FIG. 1B, all configured to receive the tightening screw.

In an embodiment, the earth-bonding clamp 202 can be fastened to any one of the plurality of first holes 204, based on convenience of coupling the earthing cable to the connector assembly.

FIG. 2D illustrates an exemplary top view of an embodiment of the nut of the proposed connector assembly coupled with an earth-bonding clamp, in accordance with the fourth embodiment of the present disclosure.

As illustrated in FIG. 2D, the nut of an embodiment of proposed connector assembly with an earth-bonding clamp is shown. In an embodiment, the nut 108 can have a hexagonal profile that can include the plurality of first holes positioned on the radially outer surface of the nut 108. As illustrated, the plurality of first holes 204-1 and 204-2 are positioned near two alternate sides of the radially outer surface of the hex profile nut.

In an exemplary embodiment, the holding screw 218 can have a male mating thread 220 around its surface that can engage with a female mating thread 222 on the inner surface of the first hole 212 of the earth-bonding clamp 202.

In an exemplary embodiment, the holding screw 218 can have a female mating thread around its surface that can engage with a male mating thread on the inner surface of the first hole of the earth-bonding clamp.

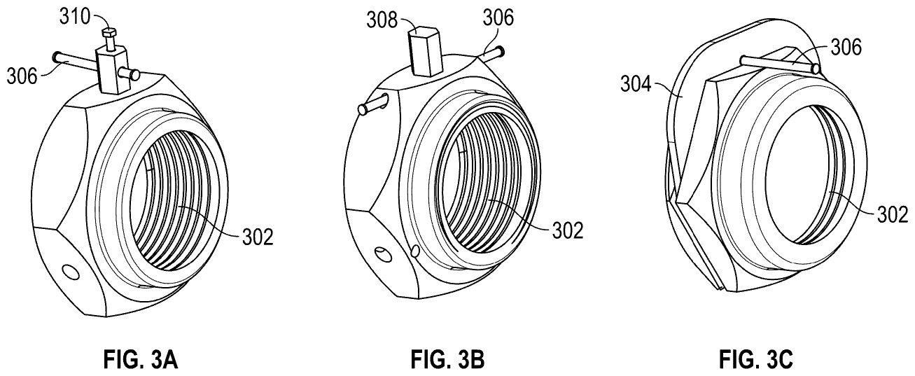

FIGS. 3A to 3C illustrates perspective views of further exemplary embodiments of nut of the proposed connector assembly, in accordance with an embodiment of the present disclosure.

In an embodiment, the radially inner surface of the nut as illustrated in FIGS. 3A to 3C can have an interior female or male thread 302, which can engage with an exterior male or female thread (not shown in figure) present on the outer surface of the at least one opening of the fitting, such that the engagement of the exterior male thread of the one or more opening and the interior female thread 302 of the nut.

As illustrated in each of FIGS. 3A to 3C, the nut of the connector assembly can be coupled with an earth-bonding clamp 308 at one of the radially outer side holes. The earth-bonding clamp 308 can be fastened at one of the plurality of holes positioned on radially outer sides of the nut. The earth-bonding clamp 308 can include a first hole drilled along two opposite sides of the earth-bonding clamp, which can enable fastening of the earthing cable 306 at the plurality of first holes. Thus, the first hole of the earth-bonding clamp 308 may serve the same or similar function as the first hole 113 as illustrated in FIG. 1A and FIG. 1B, the one or more first holes 110 as illustrated in FIG. 1C and FIG. 1D and the first hole 212 as illustrated in FIGS. 2A to 2D, all configured to allow passage of the earthing cable. The earth-bonding clamp 308 can further include a second hole positioned perpendicular to the first hole, such that the earthing cable can be tightened by a holding screw 310 inserted in the second hole. Thus, the second hole of the earth-bonding clamp 308 may serve the same or similar function as the second hole 117 as illustrated in FIG. 1A, the one or more holes 109 as illustrated in FIG. 1B and the second hole 216 as illustrated in FIGS. 2A to 2D, all configured to receive the tightening screw.

In an embodiment, the nut of the connector assembly with the earthing cable configured along at least one of the sides of the hex profile nut is shown. In an exemplary embodiment, the earthing cable can pass through a first hole drilled parallel to at least one of the sides of the nut. The nut can further include a second hole positioned on a radially outer side of the at least one of the sides of the nut, perpendicular to the first hole. The bore of second hole and the first hole cab be connected such that the earthing cable passing through the first hole can be fastened by a clamping means 308 in the second hole.

In an embodiment, the nut can further include an extended end 304 on at least one radially outer surface, which can be configured to electrically couple an earthing cable 306 at a hole positioned on its surface.

It will be appreciated that the nut illustrated in FIG. 3A, 3B or 3C may be utilised on any one of the embodiments illustrated in FIG. 1A, FIG. 1B, FIG. 1C, FIG. 1D, FIG. 2A, FIG. 2B, FIG. 2C and FIG. 2D.

It is to be appreciated that while various embodiments of the present disclosure have been elaborated with reference to a nut having hexagonal profile along a radially outer side, however the present disclosure can be implemented using nuts having any profile (any number of radially outward faces) and all such embodiments are well within the scope of the present disclosure without any limitations whatsoever.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes” and “including” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages

The present disclosure provides a connector assembly for connecting a plurality of lengths of corrugated stainless steel tubing.

The present disclosure to provide earth-bonding to a corrugated stainless steel tubing system.

The present disclosure provides a connector assembly for earth-bonding of a corrugated stainless steel tubing system.

The present disclosure provides a connector assembly for earth-bonding of a corrugated stainless steel tubing system, which is compact and easy to operate.

The present disclosure provides a connector assembly for earth-bonding of a corrugated stainless steel tubing system, which is economical and easy to assemble.

1. A connector assembly to enable the earth-bonding of corrugated stainless steel tubing, the connector assembly comprising:
a fitting comprising at least one opening to hold one end of at least one length of corrugated stainless steel tubing;
a sealing mechanism, whereby a fluid seal is achieved between the corrugated stainless steel tubing and the fitting;
a nut configured on an outer side of the at least one opening of the fitting and extends axially away from the beyond the fitting;
the nut having one or more holes positioned at one or more pre-defined positions which is spaced from an axial extent of the fitting, and
an earth-bonding clamp having and earth-bonding-earthing-cable receiving hole therethrough to electrically couple with an earth-bonding earthing cable to facilitate earth-bonding of the corrugated stainless steel tubing.

2. (canceled)

3. (canceled)

4. (canceled)

5. (canceled)

6. The connector assembly as claimed in claim 1, wherein the one or more pre-defined positions on the nut are present at any or a combination of the following positions: around circumference of the nut, radially outer side of the nut, radially outerside of the nut, and parallel to radially outer sides of the nut.

7. The connector assembly as claimed in claim 1, further comprising a tightening screw to facilitate tightening of the earthing cable in the earth-bonding-earthing-cable receiving hole, the earth-bonding clamp having a tightening screw receiving hole to receive the tightening screw therethrough.

8. The connector assembly as claimed in claim 1, wherein the sealing mechanism includes a sealing member configured between the outer side of the at least one opening of the fitting and the nut.

9. The connector assembly as claimed in claim 1, wherein the sealing mechanism includes a split collet, an inner side of the collet comprising a radially inward protruding structure configured to engage with a corrugated structure of the corrugated stainless steel tubing.

10. The connector assembly as claimed in claim 9, wherein rotation of the nut along the outer side of the at least one opening of the fitting enables compression of at least one corrugation of the corrugated stainless steel tubing between the collet and the fitting, thereby sealing the corrugated stainless steel tubing to the connector assembly.

11. The new connector assembly as claimed in claim 1, wherein the earth-bonding clamp has a male coupling member to connect to said one of said one or more holes of the nut.

12. The connector assembly as claimed in claim 11, wherein the male coupling member has a male or female thread to engage with a female or male thread on said one of the said one or more holes.

13. The connector assembly as claimed in claim 1, wherein the earth-bonding-earthing-cable receiving hole is provided through two opposing surfaces of the earth-bonding clamp.

14. The connector assembly as claimed in claim 13, wherein an axial extent of the present earth-bonding-earthing-cable receiving hole is parallel or substantially parallel to the axial extend of the fitting.

15. The connector assembly as claimed in claim 7, wherein the tightening-screw receiving hole and the earth-bonding-earthing-cable receiving hole are perpendicular or substantially perpendicular from each other and are connected to each other.

16. The connector assembly as claimed in claim 9, wherein the collet has a uniform or substantially uniform outer surface diameter along its axial extent to provide an interference fit with an inner side of said at least one opening of the fitting.

17. A connector assembly as claimed in claim 1, further comprising the earth-bonding earthing cable.

18. A corrugated stainless steel tubing assembly comprising:
a corrugated stainless steel tubing; and
the connector assembly as claimed in claim 1.

19. A corrugated stainless steel tubing assembly comprising:
a corrugated stainless steel tubing; and
the connector assembly as claimed in claim 17.

20. A connector assembly to enable the earth-bonding of corrugated stainless steel tubing, the connector assembly comprising:
a fitting comprising at least one opening to hold one end of at least one length of corrugated stainless steel tubing;
a sealing mechanism, whereby a fluid seal is achieved between the corrugated stainless steel tubing and the fitting;
a nut configured on an outer side of the at least one opening of the fitting;
wherein the connector assembly comprises one or more holes positioned at one or more pre-defined positions on or in association with the nut, said one or more holes configured to hold an earth-bonding earthing member relative to the nut to facilitate earth-bonding of the corrugated stainless steel tubing.

21. A method of earth-bonding a length of corrugated stainless steel tubing using a connector assembly, the connector assembly comprises a fitting having an opening, a sealing mechanism, a nut configured on an outer side of the opening of the fitting, the nut having one or more holes positioned at one or more pre-defined positions, and an earth-bonding clamp having an earth-bonding-earthing-cable receiving hole therethrough, the method comprises the steps of:
a] connecting the fitting to one end of the length of the corrugated stainless steel tubing via the opening of the fitting;
b] rotating the nut on the fitting to actuate the sealing mechanism to achieve a fluid seal between the length of the corrugated stainless steel tubing and the fitting;
c] connecting the earth-bonding clamp to one of said one or more holes of the nut; and
d] electrically coupling an earth-bonding earthing cable with the earth-bonding-earthing-cable receiving hole of the earth-bonding clamp.

22. A method as claimed in claim 21, further comprising a step e] of inserting a tightening screw into a tightening-screw receiving hole of the earth-bonding clamp to tighten the earth-bonding earthing cable in the earth-bonding-earthing-cable receiving hole.

23. A method as claimed in claim 21, wherein the sealing mechanism includes a split collet, wherein an inner side of the collet comprising a radially inward protruding structure which engages with a corrugated structure of the length of the corrugated stainless steel tubing in step a], and in step b] the rotation of the nut compresses at least one corrugation of the length of the corrugated stainless steel tubing between the collet and the fitting, thereby achieving the fluid seal between the length of the corrugated stainless steel tubing and the fitting.

24. A method as claimed in claim 21, wherein the nut extends axially away from the beyond the fitting and said one or more holes of the nut is spaced from an axial extent of the fitting.
